(19) United States
(12) Patent Application Publication
(10) Pub. No.: US 2024/0403019 A1
(43) Pub. Date: Dec. 5, 2024

(54) SECURE WIRELESS OVER-THE-AIR DATA TRANSFER BETWEEN MULTIPLE VEHICLE ELECTRONIC CONTROL UNITS

(71) Applicant: FCA US LLC, Auburn Hills, MI (US)

(72) Inventors: Nallamala Akshara, Telangana (IN); Kattinti Siva Krishna, Telangana (IN)

(21) Appl. No.: 18/326,712

(22) Filed: May 31, 2023

(51) Int. Cl. G06F 8/65; B60R 16/023; H04W 4/40

(52) U.S. Cl. CPC G06F 8/65; B60R 16/0231; H04W 4/40

(57) ABSTRACT

Techniques for receiving and sharing or distributing over-the-air (OTA) update data between a plurality of electronic control units (ECUs) of a vehicle include, by a controller of the vehicle, obtaining OTA update data for one of the plurality of ECUs from a remote server via long-range wireless communication, formatting the OTA update data to a packet-based file format to obtain formatted OTA update data, and sharing or distributing the formatted OTA update data with a remainder of the plurality of ECUs via short-range wireless communication, wherein receipt of the formatted OTA update data causes each of the remainder of the plurality of ECUs to perform a corresponding firmware upgrade, and wherein the remainder of the plurality of ECUs do not require their own one or more OTA update data transceivers thereby decreasing costs of the vehicle.

### FIELD

The present application generally relates to vehicle control and communication systems and, more particularly, to techniques for secure wireless over-the-air (OTA) data transfer between multiple vehicle control units.

### BACKGROUND

Today's vehicles typically receive firmware upgrades “over-the-air” (OTA) or wirelessly (e.g., via a cellular network) from a centralized server. These upgrades include, for example, bug fixes and software updates. Each electronic control unit (ECU) of a vehicle must be capable of receiving such OTA updates. There could be controller area network (CAN) malfunctions or faults that prevent OTA update date from being shared locally between ECUs. Adding hardwire communication lines between each ECU or wireless OTA transceivers to each ECU, however, increases costs, particularly in today's vehicles having a plurality of different ECUs. Depending on a powertrain configuration, a vehicle could have, for example, an engine control unit, a transmission control module (TCM), a body control module (BCM), a hybrid control processor (HCP), a battery management system (BMS), and the like. Accordingly, while such conventional vehicle control and communication systems do work for their intended purpose, there exists an opportunity for improvement in the relevant art.

### SUMMARY

According to one example aspect of the invention, an over-the-air (OTA) update data sharing or distribution system for a vehicle having a plurality of electronic control units (ECUs) is presented. In one exemplary implementation, the system comprises an OTA update data transceiver configured for long-range wireless communication between one of the plurality of ECUs and a remote server, a short-range wireless communication transceiver configured for short-range wireless communication with a remainder of the plurality of ECUs, and a controller connected to the OTA update data transceiver and the short-range wireless communication transceiver and configured to obtain, from the OTA update transceiver, OTA update data from the remote server for the one of the plurality of ECUs, format the OTA update data to a compressed packet-based file format to obtain formatted OTA update data, and share or distribute the formatted OTA update data from the short-range wireless communication transceiver to the remainder of the plurality of ECUs, wherein receipt of the formatted OTA update data causes each of the remainder of the plurality of ECUs to perform a corresponding firmware upgrade, and wherein the remainder of the plurality of ECUs do not require their own one or more OTA update data transceivers thereby decreasing costs of the vehicle.

In some implementations, the plurality of ECUs are connected to each other via a controller area network (CAN) and wherein the receipt of the OTA update data and the sharing or distribution of the formatted OTA update data is performable during a malfunction or fault of the CAN. In some implementations, there are no hardwire communication lines between the plurality of ECUs for sharing or distribution of the OTA update data or the formatted OTA update data. In some implementations, the short-range wireless communication is via a WiFi or WiFi Direct network. In some implementations, the short-range wireless communication is via a Bluetooth low energy (BLE) network.

In some implementations, the compressed packet-based file format is one of a ZIP format and a TAR format. In some implementations, the controller is configured to share or distribute the formatted OTA update data in a sequential packed-by-packed transmission and receipt confirmation process. In some implementations, the long-range wireless communication is via a cellular data network. In some implementations, the controller is the one of the plurality of ECUs connected to the OTA update data transceiver. In some implementations, the controller is a separate or standalone controller that is distinct from the one of the plurality of ECUs connected to the OTA update data transceiver.

According to another example aspect of the invention, a method of receiving and sharing or OTA update data between a plurality of ECUs of a vehicle is presented. In one exemplary implementation, the method comprises obtaining, by a controller and from an OTA update data transceiver connected to the controller, OTA update data for one of the plurality of ECUs from a remote server via long-range wireless communication, formatting, by the controller, the OTA update data to a compressed packet-based file format to obtain formatted OTA update data, and sharing or distributing, by the controller and using a short-range wireless communication transceiver connected to the controller, the formatted OTA update data with a remainder of the plurality of ECUs via short-range wireless communication, wherein receipt of the formatted OTA update data causes each of the remainder of the plurality of ECUs to perform a corresponding firmware upgrade, and wherein the remainder of the plurality of ECUs do not require their own one or more OTA update data transceivers thereby decreasing costs of the vehicle.

In some implementations, the plurality of ECUs are connected to each other via a CAN and wherein the receipt of the OTA update data and the sharing or distribution of the formatted OTA update data is performable during a malfunction or fault of the CAN. In some implementations, there are no hardwire communication lines between the plurality of ECUs for sharing or distribution of the OTA update data or the formatted OTA update data. In some implementations, the short-range wireless communication is via a WiFi or WiFi Direct network. In some implementations, the short-range wireless communication is via a BLE network.

In some implementations, the compressed packet-based file format is one of a ZIP format and a TAR format. In some implementations, the controller is configured to share or distribute the formatted OTA update data in a sequential packed-by-packed transmission and receipt confirmation process. In some implementations, the long-range wireless communication is via a cellular data network. In some implementations, the controller is the one of the plurality of ECUs connected to the OTA update data transceiver. In some implementations, the controller is a separate or standalone controller that is distinct from the one of the plurality of ECUs connected to the OTA update data transceiver.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of a vehicle having a plurality of electronic control units (ECUs) and an example over-the-air (OTA) update data sharing or distribution system according to the principles of the present application;

FIG. 2 is a dataflow diagram of an example OTA update data sharing or distribution procedure between a plurality of ECUs of a vehicle according to the principles of the present application; and

FIG. 3 is a flow diagram of an example method of receiving and sharing or distributing OTA update data between a plurality of ECUs of a vehicle according to the principles of the present application.

### DESCRIPTION

As previously discussed, adding hardwire communication lines between each electronic control unit (ECU) of a vehicle or wireless over-the-air (OTA) update data transceivers to each ECU of the vehicle increases costs, particularly in today's vehicles having a plurality of different ECUs. Accordingly, techniques are presented herein that utilize at least one ECU having wireless OTA update capabilities to act as a master controller (or “gateway”) and wirelessly distribute OTA update data (e.g., via short-range wireless communication, such as WiFi/WiFi Direct and/or Bluetooth Low Energy, or “BLE”) to a remainder of the vehicle's ECUs.

This is achievable because even legacy (older) ECUs have such short-range wireless communication capabilities. The OTA data is also shared in a particular format suitable for the receiving ECUs, such as compressed packet-based formats (ZIP, TAR, etc.), which could further include compressed or packet-based image files (JPEG, TIFF, etc.), that can be sequentially sent/received packet-by-packet. This packet-by-packet transmission process allows for small data payloads and receipt confirmation therebetween. Other non-compressed or non-packet-based file formats, such as Portable Network Graphic (PNG), may not be suitable for these techniques. The primary potential benefit of these techniques is decreased vehicle costs.

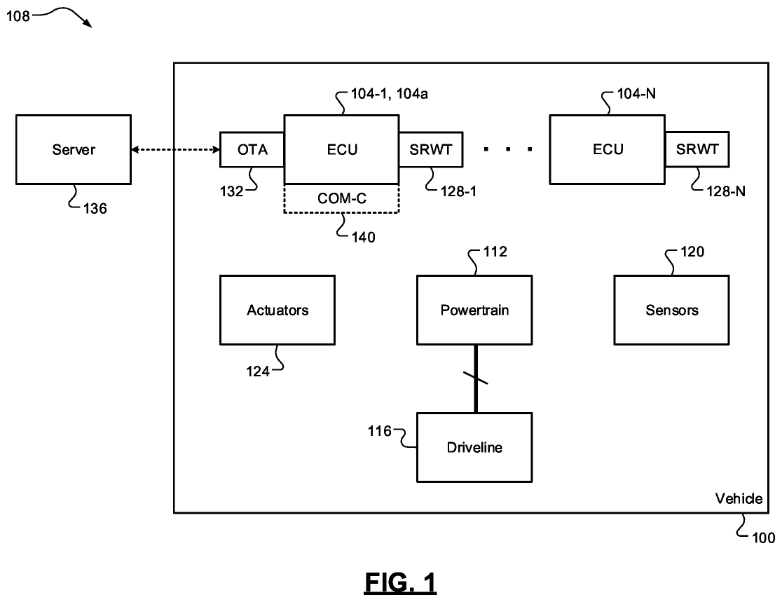

Referring now to FIG. 1, a functional block diagram of a vehicle 100 having a plurality of ECUs 104-1 . . . 104-N, where N is an integer greater than one (collectively, “a plurality of ECUs 104” or “ECUs 104”), and an example OTA update data sharing or distribution system 108 according to the principles of the present application is illustrated. The vehicle 100 generally comprises a powertrain 112 configured to generate and transfer drive torque to a driveline 116 for propulsion. Non-limiting examples of the powertrain 112 include an internal combustion engine, an electric motor, and combinations thereof.

The vehicle 100 further comprises other actuators 120 and sensors 124 for controlling various sub-systems or components of the vehicle 100 (e.g., the powertrain 108) and monitoring operation parameters of the vehicle 100. The plurality of ECUs 104 includes one particular ECU 104a (also referred to as a primary or master ECU for purposes of OTA update data sharing/distribution). For example, the primary ECU 104a could be a highest level controller of the plurality of ECUs, such as an engine control unit or a hybrid control processor (HCP). The remainder of the plurality of ECUs 104 could also be referred to as secondary or slave ECUs, but only for the purpose of describing their relationship/operation relative to the primary ECU 104a for purposes of OTA update data sharing/distribution).

The plurality of ECUs 104 are physically connected (i.e., wired) to each other via a complex controller area network (CAN, not shown), which could malfunction or fault from time to time thereby preventing communication between the ECUs 104 at least temporarily. One conventional solution to this problem is to add hardwire lines between the ECUs 104 for when the CAN malfunctions/faults, but this increases costs and complexity and thus there are no hardwire lines between the ECUs 104 of the vehicle 100 for the purposes of the OTA update data sharing/distribution techniques of the present application. Each of the plurality of ECUs 104 includes a respective (e.g., integrated) short-range wireless transceiver (“SRWT”) 128-1 . . . 128-N (collectively, “short-range wireless transceivers 128”) configured for communication via a short-range wireless communication medium, such as, but not limited to, WiFi (e.g., WiFi Direct) and Bluetooth low energy (BLE). The primary ECU 104a also comprises an OTA update data transceiver (“OTA”) 132 that is configured for communication with a remote server 136 via a long-range wireless communication medium, such as a cellular data network. The primary ECU 104a could act as a communication controller for purposes of the present application or the primary ECU 104a could optionally have associated therewith a separate or standalone communication controller (“COMM”) 140 for the OTA update receiving and/or sharing/distribution techniques of the present application.

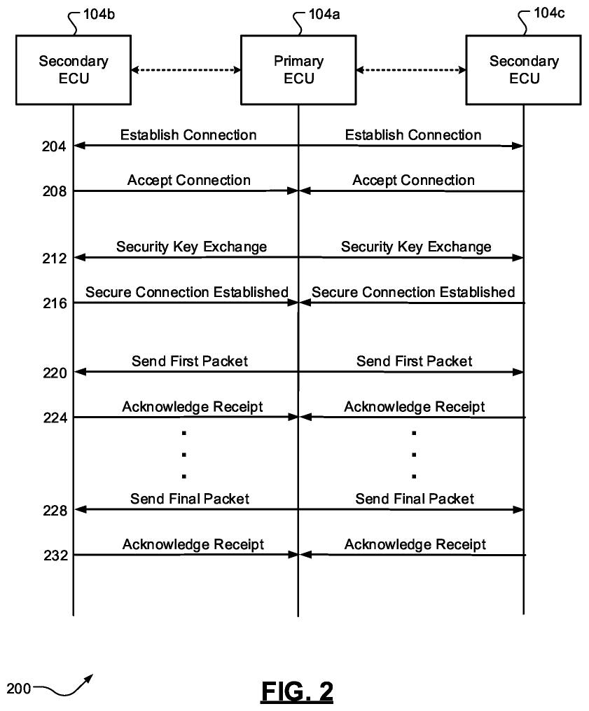

Referring now to FIG. 2, a dataflow diagram of an example OTA update data sharing or distribution procedure 200 between a plurality of ECUs of a vehicle according to the principles of the present application is illustrated. While the vehicle 100 and its components (e.g., the ECUs 104) are specifically referenced for descriptive purposes, it will be appreciated that this procedure 200 could be applicable to any suitable and similarly configured multi-ECU vehicle. The dataflow diagram 200 illustrates communication between the primary ECU 104a and two of the remainder of the plurality of ECUs 104 (hereinafter, “secondary ECUs 104b and 104c”). The illustrated communication medium is a short-range wireless communication as previously described herein, such as, but not limited to, WiFi Direct and BLE.

It will be appreciated that other short-range wireless communication protocols could also be utilized depending on the capabilities of short-range wireless communication receivers of the plurality of ECUs 104 (e.g., legacy or older ECUs may be limited to only WiFi capabilities). After the primary ECU 104a receives the OTA update data from the remote server 136 via the long-range wireless communication protocol (e.g., a cellular data network), the primary ECU 104a is then configured to share or distribute the OTA update data as shown in the dataflow diagram 200. This could include, for example, formatting the OTA update data to a desired compressed packet-based format, such as ZIP or TAR (e.g., further including JPEG or TIFF), but not a non-compressed or non-packet-based format such as PNG. Once all packets are transmitted/received, they are pieced together to collectively form the formatted OTA update data, which could also include verification of total file/image size and header information or metadata.

In a first transmission 204, the primary ECU 104a transmits a request or other suitable information to establish a connection with each of the secondary ECUs 104b, 104c via the short-range wireless communication medium. In order to complete or establish the connection, the secondary ECUs 104b and 104c respond to the initial request/transmission from the primary ECU 104a with a second transmission 208. In order to verify that this connection is secure, a security key exchange could occur from the primary ECU 104a to the secondary ECUs 104b and 104c and then back to the primary ECU 104a via third and fourth transmissions 212, 216. Once the connection is established and secured, the primary ECU 104a transmits a first packet of the formatted OTA update data to the secondary ECUs 104b and 104c via a fifth transmission 220. Upon receipt, the secondary ECUs 104b and 104c transmit back an acknowledgement of receipt to the primary ECU 104a via a sixth transmission 224.

This process then continues until a final (M^{th}. M being an integer≥1) packet is transmitted from the primary ECU 104a to the secondary ECUs 104b, 104b and acknowledgement of receipt is received back at the primary ECU 104a from the secondary ECUs 104b, 104c via two final transmissions 228, 232. Receipt of the final packets and the collective formatted OTA update data by the secondary ECUs 104b, 104c causes these ECUs 104b, 104c to perform a corresponding firmware upgrade, which could include, for example only, bug fixes and/or software updates. The primary ECU 104a can also perform a firmware upgrade either before, during, or after these transmissions.

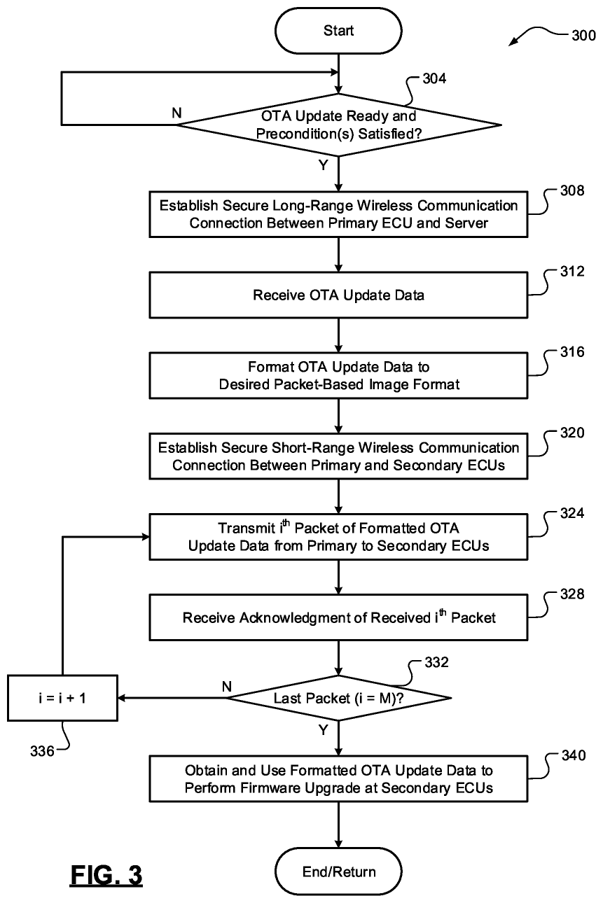

Referring now to FIG. 3, a flow diagram of an example method 300 of receiving and sharing or distributing OTA update data between a plurality of ECUs of a vehicle according to the principles of the present application is illustrated. Again, while the vehicle 100 and its components (e.g., the ECUs 104) are specifically referenced for descriptive purposes, it will be appreciated that this procedure 200 could be applicable to any suitable and similarly configured multi-ECU vehicle. In addition, while steps/functions are described as being performed by the primary ECU 104a, it will be appreciated that these could be alternatively performed by the optional separate/standalone controller 140 as previously discussed herein. At 304, the vehicle 100 determines whether an OTA update is necessary and whether a set of preconditions for doing so are satisfied.

An OTA update could be necessary, for example, when the vehicle 100 receives an OTA update notification or request, such as via the long-range communication network. The precondition(s) could include, for example, the vehicle 100 being powered up (or at least its componentry being powered up) and there being no malfunctions or faults present that would otherwise inhibit or prevent the OTA update procedure of the present application. When false, the method 300 ends or returns to 304. When true, the method 300 proceeds to 308. At optional 308, the primary ECU 104a establishes a secure connection with the server 136 via the long-range wireless communication network. It will be appreciated that this step 308 could have already been performed as a precondition for the method 300.

At 312, the primary ECU 104a receives the OTA update data from the server 136. It will be appreciated that the primary ECU 104a could perform some method of verification of the received OTA update data, such as verifying its size and/or other attributes. It will also be appreciated that the primary ECU 104a could perform its own firmware upgrade using the OTA update data at any suitable time (before, during, or after the sharing/distribution with the other secondary ECUs 104). At 316, the primary ECU 104a formats the OTA update data to a desired packed-based format (ZIP, TAR, etc.), which could include compressed/packet-based image(s) (JPEG, TIFF, etc.), to obtain formatted OTA update data. At 320, the primary ECU 104a establishes a secure connection with the other secondary ECUs 104 via the short-range wireless communication network (WiFi Direct, BLE, etc.) and using their respective transceivers 128.

At 324, the primary ECU 104a transmits an i^{th} packet of the formatted OTA update data to the secondary ECUs 104, where i is an integer that initially equals one. At 328, the primary ECU 104a receives acknowledgement of the i^{th} packet being received by and from the secondary ECUs 104. At 332, the primary ECU 104a determines whether the i^{th} packet is a final packet (i.e., whether i=M, where M is an integer≥1 and equal to the total number of packets and). When false, the method 300 returns to 324 and, at intermediary 336, increments the value of i (i=i+1). When true, the packet send/receipt process is complete and the method 300 proceeds to 340. At 340, the secondary ECUs 140 obtain the formatted OTA update data (from the received M packets) and perform a firmware upgrade using the formatted OTA update data. It will be appreciated that the secondary ECUs 140 could also perform some sort of verification of the formatted OTA update data (image/file size, header information/attributes, etc.). The method 300 then ends or returns to 304 for one or more additional cycles.

It will be appreciated that the terms “controller” and “electronic control unit” or “ECU” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. An over-the-air (OTA) update data sharing or distribution system for a vehicle having a plurality of electronic control units (ECUs), the system comprising:
an OTA update data transceiver configured for long-range wireless communication between one of the plurality of ECUs and a remote server;
a short-range wireless communication transceiver configured for short-range wireless communication with a remainder of the plurality of ECUs; and
a controller connected to the OTA update data transceiver and the short-range wireless communication transceiver and configured to:
obtain, from the OTA update transceiver, OTA update data from the remote server for the one of the plurality of ECUs;
format the OTA update data to a compressed packet-based file format to obtain formatted OTA update data; and
share or distribute the formatted OTA update data from the short-range wireless communication transceiver to the remainder of the plurality of ECUs, wherein receipt of the formatted OTA update data causes each of the remainder of the plurality of ECUs to perform a corresponding firmware upgrade,
wherein the remainder of the plurality of ECUs do not require their own one or more OTA update data transceivers thereby decreasing costs of the vehicle.

2. The system of claim 1, wherein the plurality of ECUs are connected to each other via a controller area network (CAN) and wherein the receipt of the OTA update data and the sharing or distribution of the formatted OTA update data is performable during a malfunction or fault of the CAN.

3. The system of claim 1, wherein there are no hardwire communication lines between the plurality of ECUs for sharing or distribution of the OTA update data or the formatted OTA update data.

4. The system of claim 1, wherein the short-range wireless communication is via a WiFi or WiFi Direct network.

5. The system of claim 1, wherein the short-range wireless communication is via a Bluetooth low energy (BLE) network.

6. The system of claim 1, wherein the compressed packet-based file format is one of a ZIP format and a TAR format.

7. The system of claim 1, wherein the controller is configured to share or distribute the formatted OTA update data in a sequential packed-by-packed transmission and receipt confirmation process.

8. The system of claim 1, wherein the long-range wireless communication is via a cellular data network.

9. The system of claim 1, wherein the controller is the one of the plurality of ECUs connected to the OTA update data transceiver.

10. The system of claim 1, wherein the controller is a separate or standalone controller that is distinct from the one of the plurality of ECUs connected to the OTA update data transceiver.

11. A method of receiving and sharing or distributing over-the-air (OTA) update data between a plurality of electronic control units (ECUs) of a vehicle, the method comprising:
obtaining, by a controller and from an OTA update data transceiver connected to the controller, OTA update data for one of the plurality of ECUs from a remote server via long-range wireless communication;
formatting, by the controller, the OTA update data to a compressed packet-based file format to obtain formatted OTA update data; and
sharing or distributing, by the controller and using a short-range wireless communication transceiver connected to the controller, the formatted OTA update data with a remainder of the plurality of ECUs via short-range wireless communication, wherein receipt of the formatted OTA update data causes each of the remainder of the plurality of ECUs to perform a corresponding firmware upgrade,
wherein the remainder of the plurality of ECUs do not require their own one or more OTA update data transceivers thereby decreasing costs of the vehicle.

12. The method of claim 11, wherein the plurality of ECUs are connected to each other via a controller area network (CAN) and wherein the receipt of the OTA update data and the sharing or distribution of the formatted OTA update data is performable during a malfunction or fault of the CAN.

13. The method of claim 11, wherein there are no hardwire communication lines between the plurality of ECUs for sharing or distribution of the OTA update data or the formatted OTA update data.

14. The method of claim 11, wherein the short-range wireless communication is via a WiFi or WiFi Direct network.

15. The method of claim 11, wherein the short-range wireless communication is via a Bluetooth low energy (BLE) network.

16. The method of claim 11, wherein the compressed packet-based file format is one of a ZIP format and a TAR format.

17. The method of claim 11, wherein the controller is configured to share or distribute the formatted OTA update data in a sequential packed-by-packed transmission and receipt confirmation process.

18. The method of claim 11, wherein the long-range wireless communication is via a cellular data network.

19. The method of claim 11, wherein the controller is the one of the plurality of ECUs connected to the OTA update data transceiver.

20. The method of claim 11, wherein the controller is a separate or standalone controller that is distinct from the one of the plurality of ECUs connected to the OTA update data transceiver.
